(19) United States
(12) Patent Application Publication
(10) Pub. No.: US 2015/0146415 A1
(43) Pub. Date: May 28, 2015

(54) LIGHTING DEVICE FOR PROJECTING A GOBO IMAGE

(71) Applicant: Wavien, Inc., Valencia, CA (US)

(72) Inventor: Kenneth LI, Arcadia, CA (US)

(21) Appl. No.: 14/551,918

(22) Filed: Nov. 24, 2014

Related U.S. Application Data
(60) Provisional application No. 61/907,454, filed on Nov. 22, 2013.

(51) Int. Cl. F21V 14/06; F21V 11/00; F21V 13/02; F21L 4/00

(52) U.S. Cl. CPC F21V 14/065; F21L 4/00; F21V 11/00; F21V 13/02; F21Y 2101/02
USPC 362/157; 362/277

(57) ABSTRACT

A lighting device includes an LED light source for emitting light in a first direction about an axis, a projection lens mounted on the axis, and a gobo having a preselected design which is mountable along the axis between the LED light source and lens to intercept at least some of the emitted light. The lens is moveable along the axis, preferably positionable at least at three axial positions. The first such axial position is the distance from the LED light source corresponding to the focal point of the lens. The second axial position is the distance from the gobo corresponding to the focal point of the lens. The third axial position is a distance from the LED light source corresponding to less than the focal point of the lens. In one embodiment, the lighting device includes a recycling collar having a central opening through which the axis extends. In another embodiment, the projection lens is a TIR lens.

### CROSS-REFERENCE TO RELATED APPLICATIONS

The present application claims priority on U.S. provisional patent application No. 61/907,454, filed on Nov. 22, 2013.

### BACKGROUND OF THE INVENTION

For advertising, product promotion, and toy applications, it is often desirable to project an image from a simple device pointing anywhere one desires. Examples of devices which act as light sources include a flashlight, a spot light, or a search light. The projected image can be formed by several types of sources, such as a transparency, a slide, or a gobo.

A gobo is a thin circular plate with holes. Gobos are placed in the path of a light source, so that the holes create a pattern of emitted light. Gobos are currently used in a number of lighting applications, such as theaters, movies, operas, television, concerts, weddings and other social events, nightclubs, corporate conferences, displays, architectural lighting, and education.

Gobos can be made from various materials including steel, glass, and plastic/transparent materials. The material generally depends upon the intended application. The gobo is placed in the focal plane of the light source, e.g., a spotlight, a tungsten halogen light fixture, or an LED, and the desired pattern is projected onto whatever surface the light source is aimed, for example a floor, a wall, or a screen.

It is desirable that the light source, e.g., a flashlight, functions normally when the image projecting function is not being used. This makes the light source a versatile, multi-function device. When applied to a flashlight, gobo images, for example images of various sports team logos or Disney characters, etc., may be desirably used. The flashlight functions to project a gobo image when desired, and functions as a normal flashlight when a gobo image is not being projected. This makes the flashlight very useful for football and basketball fans, Disney character fans, etc.

FIG. 1 shows a conventional flashlight 10 with a light source 12 and a reflector 14. The light source 12 may be a filament light bulb or an LED. The reflector 14 can be parabolic or another appropriate shape to create the desired output beam profile 16. In the FIG. 1 example, the beam profile 16 is collimated and extends in an axial direction. Other beam profiles, however, may be created as desired.

FIG. 2 shows an alternative flashlight 10a which includes, in place of the reflector 14 of FIG. 1, a projection lens 18 which is located in the direction of light emission at a distance “f” from the light source 12. The distance “f” preferably corresponds at least approximately to the focal length of the lens 18 such that the beam profile 16 is collimated. As in the case of FIG. 1, the lens 18 may be positioned closer than “f” or further away than “f” if other beam profiles are desired. FIG. 3 shows a flashlight 10b which is similar to FIG. 2, except that the projection lens 18 is located closer to the light source 12 than the focal distance “f” so as to create an outwardly diverging beam profile 17. A FIG. 3 configuration may be desirable, for example, where there is a large area needs to be illuminated.

### SUMMARY OF THE INVENTION

A lighting device includes an LED light source for emitting light in a first direction about an axis, a projection lens mounted on the axis, and a gobo having a preselected design which is mountable along the axis between the LED light source and lens to intercept at least some of the emitted light. The lens is moveable along the axis, preferably positionable at least at three axial positions. The first such axial position is the distance from the LED light source corresponding to the focal point of the lens. The second axial position is the distance from the gobo corresponding to the focal point of the lens. The third axial position is a distance from the LED light source corresponding to less than the focal point of the lens. In one embodiment, the lighting device includes a recycling collar having a central opening through which the axis extends. In another embodiment, the projection lens is a TIR lens.

### BRIEF DESCRIPTION OF THE DRAWINGS

FIG. 1 is a schematic, side view of a known type of flashlight;

FIG. 2 is a schematic, side view of another known type of flashlight;

FIG. 3 is a schematic, side view of a third known type of flashlight;

FIG. 4 is a schematic, side view of a GOBO projector in accordance with the invention;

FIG. 5 is a schematic, front view of a GOBO image for use in the projector of FIG. 4;

FIG. 6 is a schematic, side view of another GOBO projector in accordance with the invention;

FIG. 7 is a schematic, side view of yet another GOBO projector in accordance with the invention;

FIG. 8 is a schematic, side view of a known type of GOBO projector according to the invention; and

FIG. 9 is a schematic, side view of a further GOBO projector in accordance with the invention.

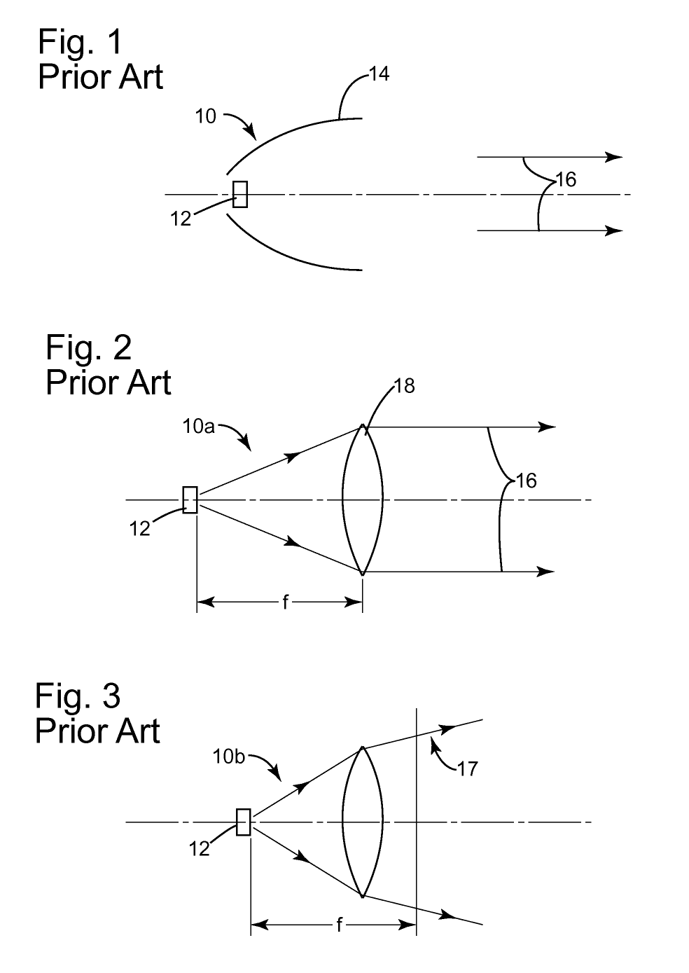

### DETAILED DESCRIPTION OF THE INVENTION

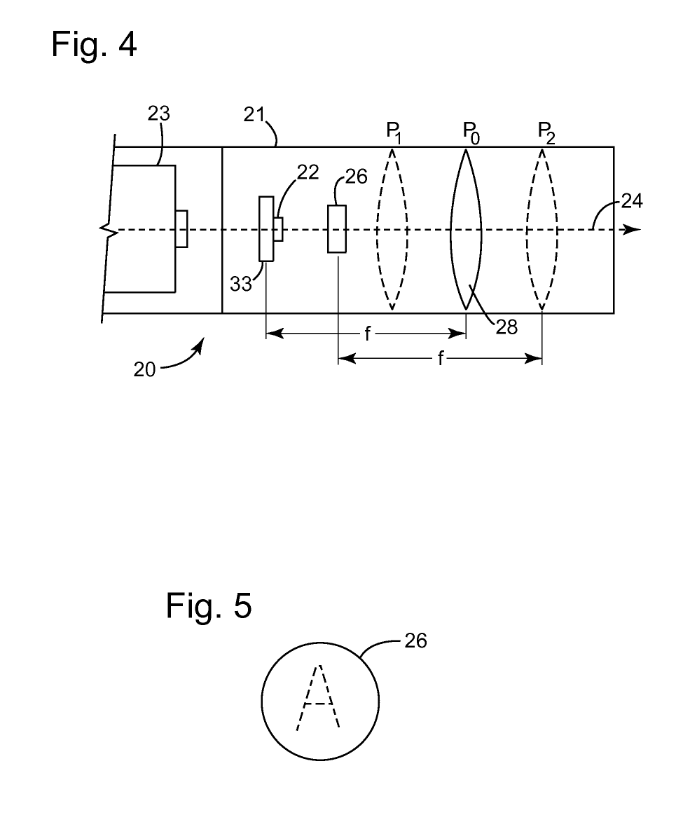

FIG. 4 is a side view of a flashlight 20 having a body 21 for securing an LED light source 22, which is mounted on a heat sink 33, and a battery 23. The LED light source 22 emits light in a general direction having an axis 24. A gobo 26 is centered in the light path axis 24 between the LED light source 22 and a projection lens 28. The lens 28 is centered about the light path axis 24 and can be positioned at various distances from the LED light source 22 or from the gobo 26. For purposes of illustration, the lens 28 is movable along the light path axis 24 and is shown in three positions P0, P1, and P2.

In the position P0, the projection lens 28 is at a distance “f” from the light source 22, which corresponds to the focal length of the lens 28. The light output from the light source will accordingly be collimated into a narrow beam to extend parallel to the axis 24. If the projection lens 28 is located at the position P1, where the lens 28 is nearer to the LED light source 22 than the focal length “f” of the lens 18, the light output will diverge, as shown in FIG. 3. When the projection lens 28 is at the position P2, the lens 28 will be approximately a focal length “f” away from the gobo 26. The image of the gobo 26 will thus be projected at a certain distance from the projection lens 28.

In FIG. 4, the lens positions P0 and P1 represent two standard flashlight configurations, either of which may be used when the gobo 26 is removed from the flashlight. The lens position P2 represents a preferred projection position for displaying a gobo 26.

An example of a gobo 26 is shown in FIG. 5 which is for displaying the letter “A.” Depending on the image on the gobo 26, there will be a small amount of light loss absorbed by the gobo 26. In practice, the gobo 26 will occupy only a small portion of the illuminated area. Thus, the amount of loss due to the gobo 26 will be minimum and, other than the small loss, the performance of the flashlight will not be degraded.

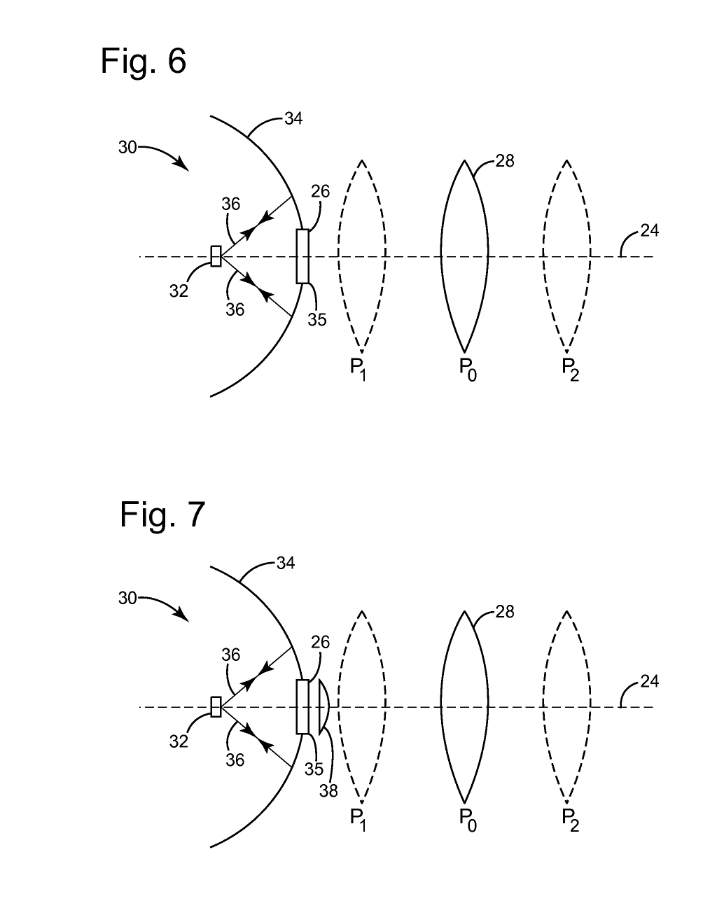

FIG. 6 illustrates another example of a flashlight 30 (in which the body is removed for simplicity) having an LED light source 32 which emits light generally in the direction of the axis 24. A recycling collar 34 is centered on the axis 24 for recycling light greater than a predetermined angle 36 back to the LED light source 32 for recycling. The recycling collar 34 can be spherical or dual parabolic in shape. The LED light source 32 can be a single color LED of several LEDs with different colors. Preferably, the multiple LEDs are assembled onto the same heat sink (not shown) to provide a multi-color output.

The recycling collar 34 includes an opening 35 centered about the axis 24, in which the gobo 26 is disposed. A projection lens 28 is centered along the axis 24 and movable, e.g., between positions P0, P1, and P2 as described in connection with FIG. 4. Thus, in the FIG. 6 embodiment, small angle light is directed at the gobo 26 to project an output image. Preferably, the side of the gobo 26 facing the LED light source 32 is reflective so as to recycle light which is not emitted, back to the LED light source 32. Larger angle light beams 36 impact the internal surface of the recycling collar 34, which is also reflective, to be reflected back to the LED light source 32.

FIG. 7 is the same as the embodiment shown in FIG. 6 except that a field lens 38 is positioned between the gobo 26 and the projection lens 28. Preferably, the field lens 38 is positioned relatively close to the gobo 26. The image output from the gobo 26 will thus be directed towards the projection lens 28 with higher efficiency. A field lens 38 may also be used in the embodiment of FIG. 4 with the field lens 38 mounted proximate to the gobo 26.

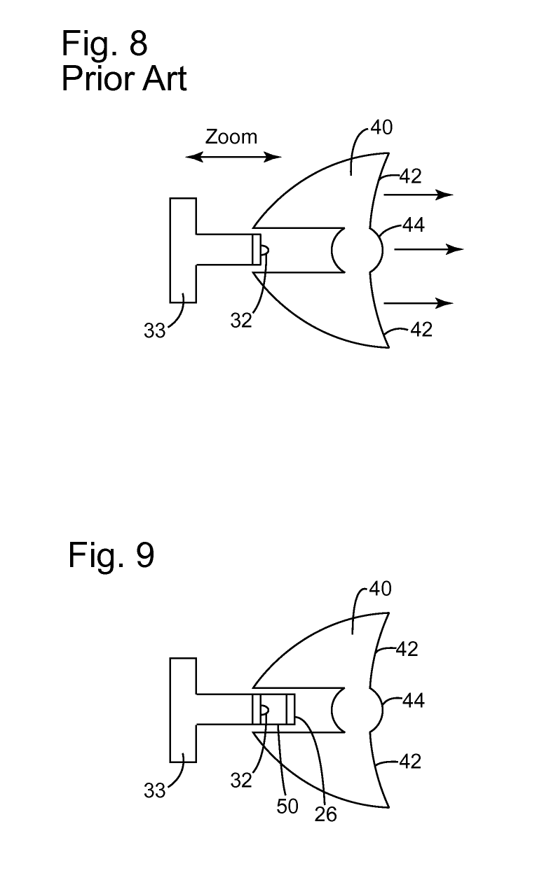

FIG. 8 illustrates a flashlight (again, with the body omitted) using a total internal reflection (“TIR”) lens 40. The lens 40 has an outer, annular output 42 and an inner, generally circular output 44. The LED light source 32 is mounted on a heat sink 33. Higher angle emitted light from the light source 32 is reflected by total internal reflection producing the outer output 42. Lower angle emissions are directed toward the center circular output 44 of the lens 40 and are emitted as an inner output 44 at the center of the output end of the lens 40. At an optimum position, both outputs 42 and 44 are collimated with different divergences due to the finite space of the LED light source 32.

In order to use the flashlight of FIG. 8 to project a gobo, as shown in FIG. 9 the gobo 26 is mounted on a standoff 50 which is secured at a predetermined distance from the LED light source 32 in the direction in which light is emitted. The LED light source 32 is preferably at the focal point of the center lens 44 so that a collimated beam is produced. The LED light source 32 and gobo 26 are secured to one another so as to be moveable backwards from the TIR lens 40 (towards the left in FIG. 8) such that the gobo 26 is at the focal point position of the inner lens 44 [Ken, is that correct?] and the image of the gobo 26 will be projected onto the screen or other surface (not shown). At such position, in order to eliminate reflected light, the output from lens portion 44 completely eliminates the interference of the light from the gobo image. The system is designed such that the LED is positioned completely outside of the TIR lens 40.

In one embodiment, the LED light source 32 is mounted relative to the TIR lens 40 to move relative to the lens 40 in a direction toward and away from the outputs 42, 44, producing beams of different divergences to produce light spots of different sizes.

Although the foregoing embodiments are described as flashlights, the invention may be employed with other types of lighting devices such as spot lights or search lights, and can be powered either by battery or power lines.

The foregoing represent preferred embodiments of the invention. Variations and modifications of the embodiments will be evident to persons skilled in the art. All such variations and modifications are intended to be part of the invention, as defined by the following claims.

1. A lighting device comprising an LED light source for emitting light in a first direction about an axis; a projection lens mounted on said axis; and a gobo having a preselected design which is mountable along said axis between said LED light source and said lens to intercept at least some of the emitted light; wherein said lens is moveable along said axis.

2. The lighting device of claim 1, wherein said lens is positionable at least at two axial positions, one of which is distance from the LED light source corresponding to the focal point of the lens, and another of which is the distance from the gobo corresponding to the focal point of the lens.

3. The lighting device of claim 2, wherein said lens is positionable at least at three axial positions, the third such axial position being a distance from the LED light source corresponding to less than the focal point of the lens.

4. The lighting device of claim 3, further comprising a recycling collar centered on said axis for reflecting larger angle emitted beams of light from said LED light source back on said LED light source, and having an opening centered on said axis for passing lower angle emitted beams of light from said LED light source; wherein said gobo is mountable in said center opening.

5. The lighting device of claim 4, further comprising a field lens positioned on said axis between said gobo and said reflective lens.

6. The lighting device of claim 2, wherein said projection lens is a TIR lens having an inner opening surrounded by an annular, outer opening.

7. The lighting device of claim 1, wherein said device is a flashlight having a battery or other portable power source for powering the LED light source.
